(19) United States
(12) Patent Application Publication
(10) Pub. No.: US 2026/0319492 A1
(43) Pub. Date: Oct. 15, 2026

(54) SYSTEM

(71) Applicant: RIKEN, Wako-shi (JP)

(72) Inventors: Koji OCHIAI, Wako-shi (JP); Kazunari KAIZU, Wako-shi (JP); Koichi TAKAHASHI, Wako-shi (JP)

(21) Appl. No.: 19/483,072

(22) PCT Filed: May 17, 2024
(86) PCT No.: PCT/JP2024/018261

§ 371 Date: Nov. 10, 2025

(30) Foreign Application Priority Data
May 17, 2023 (JP) 2023-081712
May 2, 2024 (JP) 2024-074900

(51) Int. Cl. G05D 1/229; G05D 1/246; G05D 101/15; G05D 105/80; G05D 107/00; G05D 109/12; G05D 111/10; G06Q 10/20

(52) U.S. Cl. CPC G05D 1/229; G05D 1/246; G06Q 10/20; G05D 2101/15; G05D 2105/80; G05D 2107/68; G05D 2109/12; G05D 2111/17

(57) ABSTRACT

In a system that includes a management server, a robot, and a sensor that measures an environment including a space of an action range of the robot, the management server includes a reception unit configured to receive a mission, and a command unit configured to generate a command on the basis of the mission and transmit the command to the robot, the command includes a first command representing a state after execution of the mission, and the robot includes a state specification unit configured to specify an environmental state of the robot including a state of an article handled by the robot on the basis of measurement data of the sensor, and an instruction unit configured to receive the command and drive the robot so that a state of the robot approaches a state represented by the command on the basis of a difference between the specified state and the state represented by the command.

### TECHNICAL FIELD

The present invention relates to a system.

Priority is claimed on Japanese Patent Application No. 2023-081712, filed May 17, 2023, and Japanese Patent Application No. 2024-074900, filed May 2, 2024, the contents of which are incorporated herein by reference.

### BACKGROUND ART

Research and development are underway to automate tasks such as scientific experiments.

### CITATION LIST

### Patent Document

Patent Document 1: U.S. Patent Application, Publication No. 2015/242395

### SUMMARY OF INVENTION

### Technical Problem

Automated systems are difficult to maintain.

An object of the present invention is to solve the problems described above and provide a system with self-maintenance capabilities.

### Solution to Problem

According to one aspect of the present invention, in a system that includes a management server, a robot, and a sensor that measures an environment including a space of an action range of the robot, the management server includes a reception unit configured to receive a mission, and a command unit configured to generate a command on the basis of the mission and transmit the command to the robot, the command includes a first command representing a state after execution of the mission, and the robot includes a state specification unit configured to specify an environmental state of the robot including a state of an article handled by the robot on the basis of measurement data of the sensor, and an instruction unit configured to receive the command and drive the robot so that a state of the robot approaches a state represented by the command on the basis of a difference between the specified state and the state represented by the command.

### Advantageous Effects of Invention

According to the present invention, it is possible to provide a system having self-maintenance capabilities.

### BRIEF DESCRIPTION OF DRAWINGS

FIG. 1 is a diagram which shows a configuration of a system 1 according to a first embodiment.

FIG. 2 is a diagram which shows a configuration of a robot 21.

FIG. 3 is a diagram which shows an example of a configuration of a control unit 25.

FIG. 4 is a diagram which shows a configuration of a management server 11.

FIG. 5 is a flowchart which shows an operation of the management server 11.

FIG. 6 is a flowchart which shows the operation of the management server 11 in step S12 and an operation of the robot 21 at that time.

FIG. 7 is a flowchart which shows the operation of the management server 11 in step S13 and the operation of the robot 21 at that time.

FIG. 8 is a diagram which shows an example of implementation of the system 1.

FIG. 9 is a diagram which shows a relationship between a camera, a computer, an actuator, and an installation space.

### DESCRIPTION OF EMBODIMENTS

Hereinafter, embodiments of the present invention will be described in detail with reference to the drawings.

### First Embodiment

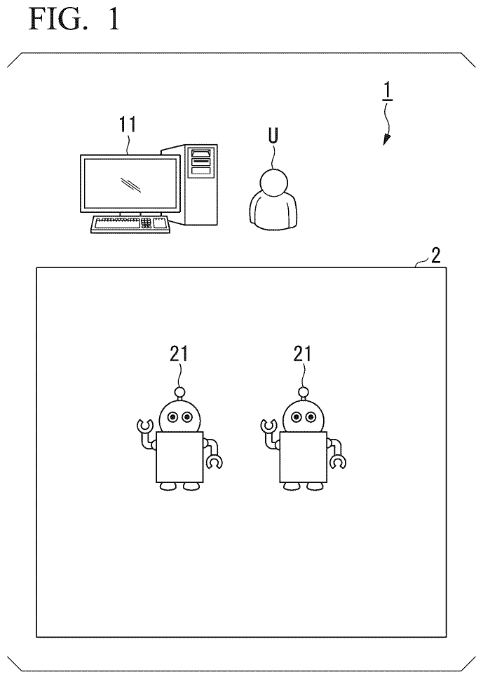

FIG. 1 is a diagram which shows a configuration of a system 1 according to a first embodiment. The system 1 includes a management server 11 and a robot 21.

The management server 11 receives a mission from a user U. The mission includes, for example, content of an experiment to be performed by the robot 21, The management server 11 acquires data regarding a predetermined action range 2 of the robot 21 from the robot 21. The predetermined action range 2 is, for example, a laboratory in which the robot 21 performs experimental tasks. The management server 11 generates a command and issues an instruction to the robot 21. The robot 21 drives in accordance with commands from the management server 11 within the predetermined action range 2.

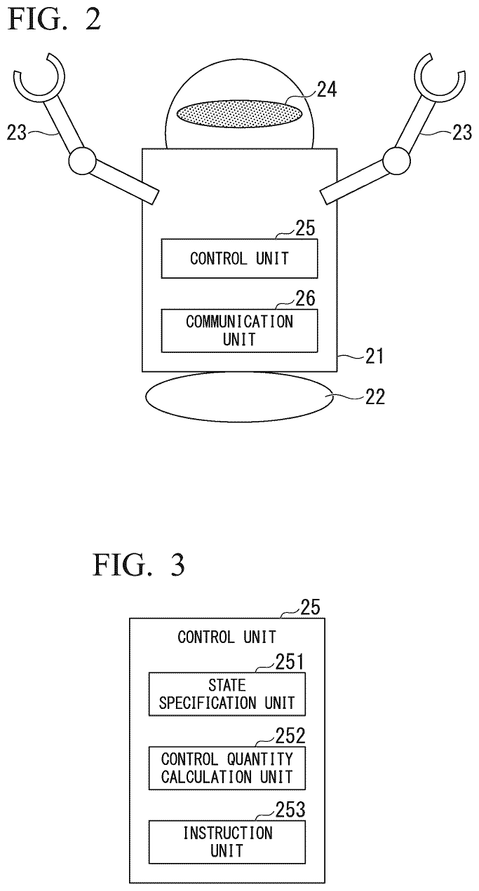

FIG. 2 is a diagram which shows a configuration of the robot 21. The robot 21 includes a traveling device 22, a manipulator 23, a sensor 24, a control unit 25, and a communication unit 26.

The traveling device 22 is provided below the robot 21 and supports an entirety of the robot 21. The traveling device 22 is, for example, an endless track, and rotates to move the robot 21 within the action range 2.

The manipulator 23 grasps equipment within the action range 2. The manipulator 23 is, for example, provided with servo motors at each joint, which control joint angles. The manipulator 23 feeds back information regarding the joint angles and whether it is grasping the equipment to the control unit 25, The manipulator 23 may include a sensor in a grasping portion, which determines whether it is grasping an object and provides feedback.

The sensor 24 senses surroundings of the robot 21 and acquires sensing data. The sensor 24 is, for example, a camera, and captures images of at least the area in front of the robot 21. The sensing data includes images captured by the camera. The sensor 24, for example, is a LiDAR that measures three-dimensional space. The sensing data includes data on the three-dimensional space measured by the LiDAR.

The control unit 25 controls the traveling device 22 and the manipulator 23 on the basis of the sensing data from the sensor 24 and commands received from the management server 11. FIG. 3 is a diagram which shows an example of a configuration of the control unit 25.

The control unit 25 includes a state specification unit 251, a control quantity calculation unit 252, and an instruction unit 253.

The state specification unit 251 specifies a self-state and an environmental state of the robot 21 on the basis of the measurement data from the sensor 24. The self-state of the robot 21 indicates a state of the robot 21. The environmental state of the robot 21 indicates a state of a surrounding environment of the robot 21 and a state of equipment used by the robot 21.

The state specification unit 251 recognizes equipment such as a test tube by analyzing an image. Image analysis is implemented by, for example, a machine learning object recognition model. The state specification unit 251 generates a map using SLAM on the basis of measurement data from LiDAR. The state specification unit 251 specifies a three-dimensional position and three-dimensional posture of the equipment on the basis of the map generated by SLAM.

The state specification unit 251 acquires information on whether an object is being grasped through feedback from the manipulator.

When equipment is recognized by the image analysis, the number of pieces of equipment may be specified by an object recognition model. A volume of equipment such as liquid is detected using a dedicated trained model. The model for detecting the volume of equipment is trained to calculate a volume based on an image using a training dataset consisting of a combination of images of, for example, containers filled with liquid and a volume of the liquid.

The control quantity calculation unit 252 calculates control quantities of the traveling device 22 and the manipulator 23 on the basis of a difference between the self-state and environmental state of the robot 21 specified by the state specification unit 251 and a state represented by a command from the management server 11. The control quantity of the traveling device 22 is, for example, a traveled distance, the number of rotations, or a traveling direction. The control quantity of the manipulator 23 is, for example, a joint angle.

Calculations by the control quantity calculation unit 252 are implemented using reinforcement learning. More specifically, the difference between the self-state and environmental state of the robot 21 specified by the state specification unit 251 and the state represented by the command from the management server 11 is used as a reward to calculate a behavior of the robot 21 in the self-state and environmental state of the robot 21 specified by the state specification unit 251. Here, the behavior is a control quantity of the traveling device 22 and the manipulator 23.

As described above, since the control quantity calculation unit controls the traveling device 22 and the manipulator 23 to minimize the difference between the self-state and environmental state of the robot 21 and the state represented by the command at a corresponding time, it is possible to perform adjustment even if external disturbances occur.

The instruction unit 253 instructs the traveling device 22 and the manipulator 23 to control the quantities. The traveling device 22 and the manipulator 23 receive the instruction and perform movement, rotation, and the like.

The control quantity calculation unit 252 may calculate the control quantities of the traveling device 22 and the manipulator 23 even without a command from the management server 11. At this time, the control quantity calculation unit 252 calculates the control quantities of the traveling device 22 and the manipulator 23 on the basis of the ideal state. The ideal state is a state in which equipment is in a standard position and has a standard remaining amount. This allows the robot 21 to autonomously maintain its self-state and environmental state in the ideal state.

The communication unit 26 receives s command from the management server 11. The communication unit 26 notifies the management server 11 of the self-state and environmental state of the robot 21.

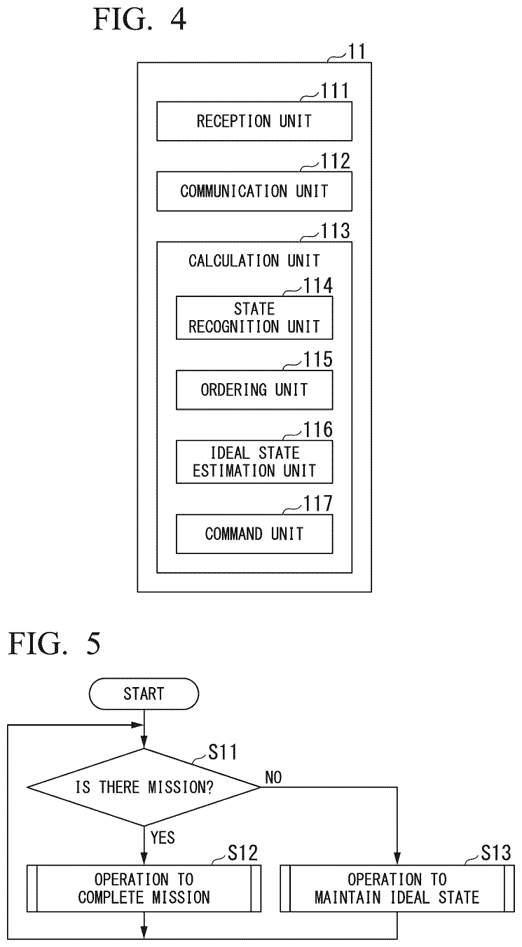

FIG. 4 is a diagram which shows a configuration of the management server 11. The management server 11 includes a reception unit 111, a communication unit 112, and a calculation unit 113, The reception unit 111 receives a mission from a user U. A mission is an experimental instruction to be performed by the robot 21. The experimental instruction is expressed as a change in a state of the system 1. The experimental instruction includes information regarding a substance contained in a test tube (for example, a state in which 1 mg of a reagent A is contained in a test tube X), a position of the test tube (for example, a state in which the test tube X is present on a rack Y), and processing to be applied to the test tube (for example, a state in which the test tube X has been heated for 100 seconds, a state in which content of the test tube X has been analyzed using a method Z).

The reception unit 111 receives, for example, a mission via an input device such as a keyboard, or via wireless communication by the communication unit 112, which will be described below.

In addition, the mission includes a result delivery instruction to have the robot 21 deliver a result of an experiment.

The communication unit 112 transmits and receives data to and from the robots 21. The communication unit 112 receives the self-state and environmental state of each robot 21 from each robot 21. The self-state of the robot 21 includes, for example, a position and a state of a task of the robot 21. The environmental state of the robot 21 includes, for example, a position and a remaining amount of equipment around the robot 21.

In addition, the communication unit 112 may receive data including information on a mission from other communication devices.

The calculation unit 113 includes a state recognition unit 114, an ordering unit 115, an ideal state estimation unit 116, and a command unit 117.

The state recognition unit 114 recognizes the state of the system 1 on the basis of the self-state and environmental state of the robot 21 acquired from each robot 21. The state recognition unit 114 recognizes the state of the system 1 by receiving results of image analysis and the like as the self-state and environmental state of the robot 21. However, the state recognition unit 114 may also acquire the environmental state of the robot 21 by acquiring raw data such as images from the robot 21 and analyzing the images. At this time, the state specification unit 251 of the robot 21 does not need to perform processing such as image analysis.

The state recognition unit 114 may determine whether a command has been completed on the basis of the state of the system 1 after the command is transmitted to the robot 21.

The ordering unit 115 orders equipment on the basis of the state of the system 1 recognized by the state recognition unit 114. For example, the ordering unit 115 orders equipment when the remaining amount of equipment in the recognized state of the system 1 is low. The ordering unit 115 also orders repairs for the robot 21. For example, the ordering unit 115 determines that the robot 21 needs repairs and orders repairs when a rate at which the robot 21 completes a command is equal to or less than a predetermined value. The ordering unit 115 determines that the robot 21 needs repairs and orders repairs when the difference between the self-state and environmental state of the robot 21 and the state represented by the command does not decrease and is equal to or greater than a predetermined value.

The ideal state estimation unit 116 estimates an ideal state of the robot 21 in the action range 2 on the basis of a history of past missions. For example, the ideal state estimation unit 116 predicts missions to be performed in the future on the basis of the history of past missions, performs a simulation of a case in which missions predicted to be performed in the future in a plurality of different states are performed, and estimates an optimal state based on the plurality of different states, The ideal state estimation unit 116 predicts the missions to be performed in the future by, for example, pattern recognition of past missions.

The command unit 117 generates commands to control the robot 21. The commands include a first command representing the state after a mission is executed and a second command representing the ideal state of the system 1. The command unit 117 transmits the generated commands to each robot 21.

The command unit 117 generates a first command based on a mission received by the reception unit 111 and the state of the system 1 recognized by the state recognition unit 114. The command unit 117 specifies the robots 21 capable of implementing each experimental instruction included in the mission and assigns each experimental instruction to the specified robot 21. When a mission is carried out by a plurality of robots 21, the mission may include instructions for the robots to hand over equipment.

The command unit 117 generates a second command based on the ideal state estimated by the ideal state estimation unit 116 and the state of the system 1 recognized by the state recognition unit 114. The second command includes, for example, a command to have the robot 21 move equipment from an inventory place where it is placed to a specified position.

FIG. 5 is a flowchart which shows an operation of the management server 11. When the reception unit 111 has received a mission (YES in step S11), the management server 11 performs an operation to complete the mission (step S12). When the reception unit 111 has not received a mission (NO in step S11), the management server 11 performs an operation to maintain the ideal state (step S13).

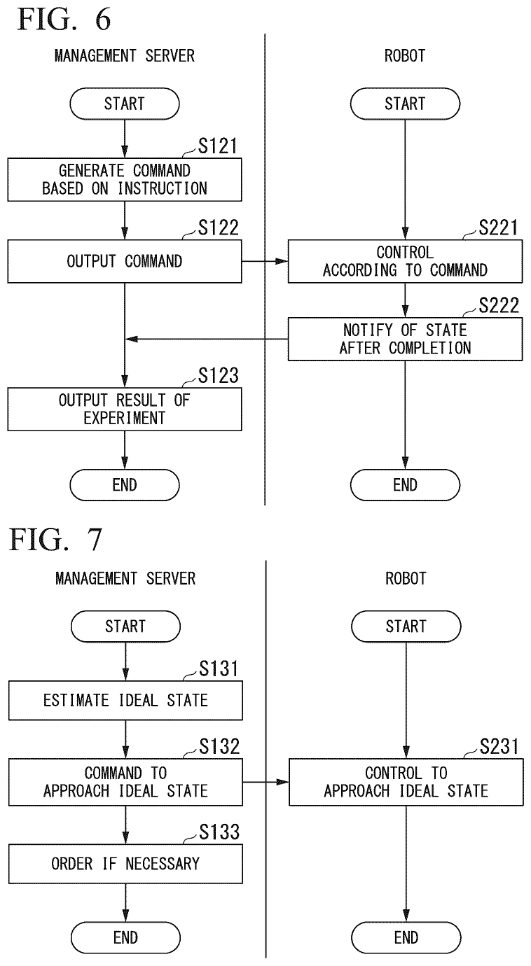

FIG. 6 is a flowchart which shows the operation of the management server 11 in step S12 and the operation of the robot 21 at that time. The command unit 117 generates a first command representing the state after a mission is executed (step S121). The command unit 117 then outputs the command to the robot 21 (step S122). When the robot 21 receives the command, the control quantity calculation unit 252 calculates the control quantities of the traveling device 22 and the manipulator 23, and the instruction unit 253 instructs the traveling device 22 and the manipulator 23 about the control quantities, thereby controlling the robot 21 according to the command (step S221). After the command is completed, the communication unit 26 of the robot 21 notifies the management server 11 of the self-state and environmental state of the robot 21 after the command is completed (step S222). In the management server 11, the state recognition unit 114 recognizes the state of the robot 21 after the command is completed and outputs a result of an experiment (step S123).

Note that in the flowcharts shown in FIGS. 5 and 6, it is determined whether there is a mission each time in step S11. However, when there is a mission, it may be completed all at once in step S12. In this case, final experiment results may be output all at once for all missions.

FIG. 7 is a flowchart which shows the operation of the management server 11 in step S13 and the operation of the robot 21 at that time. The ideal state estimation unit 116 estimates the ideal state of the robot 21 (step S131), The command unit 117 generates a second command and outputs it to the robot 21 (step S132). The robot 21 receives the command, and the control quantity calculation unit 252 calculates the control quantities of the traveling device 22 and the manipulator 23 on the basis of the ideal state. The instruction unit 253 instructs the traveling device 22 and the manipulator 23 about the control quantities (step S231). The ordering unit 115 of the management server 11 orders equipment, if necessary, on the basis of the state of the system 1 (step S133).

As described above, in the present embodiment, the management server 11 receives a mission, generates a command based on the mission, and transmits it to the robot 21. The robot 21 specifies the environmental state, receives the command, and drives itself so that its state approaches the state represented by the command. This allows the robot 21 to complete the mission even when there are changes or external disturbances in the environment.

In addition, when the robot 21 does not receive a first command representing the state after a mission is executed, it drives itself so that a difference between the state of the robot 21 and the ideal state of the robot 21 satisfies a specified requirement. This allows the robot 21 to be maintained in the ideal state.

Moreover, by transmitting a second command representing the ideal state from the management server 11 to the robot 21, the ideal state can be changed from the management server 11 side as appropriate. This makes it possible to increase availability of the system 1.

Moreover, the robot 21 can perform optimal driving by determining a drive quantity using a reinforcement learning algorithm that uses a reward based on the difference between the state of the robot 21 and the state represented by the command.

Furthermore, the management server 11 orders replenishment of missing articles in the state of the robot with respect to the state represented by the command, thereby preventing a lack of an article and increasing availability. Furthermore, the robot 21 collates data of articles received in response to the order with content of the order and manages the articles, thereby automatically replenishing the articles and increasing availability.

Furthermore, the management server 11 estimates a state in which future missions can be executed as an ideal state on the basis of missions executed in the past, thereby automatically bringing the ideal state closer to the optimal state.

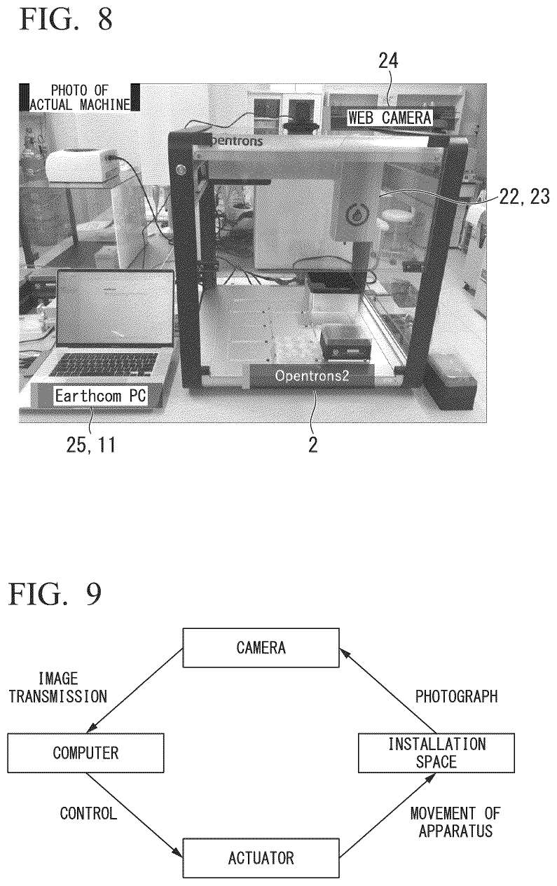

FIG. 8 is a diagram which shows an example in which the system 1 is implemented. In the example shown in FIG. 8, the system 1 includes a camera, an actuator, and a computer. The camera corresponds to the sensor 24 in the embodiment. The actuator corresponds to the traveling device 22 and the manipulator 23 in the embodiment. The computer corresponds to the control unit 25 and the management server 11 in the embodiment.

FIG. 9 is a diagram which shows a relationship between the camera, the computer, the actuator, and installation space. The camera photographs installation space of apparatuses. The installation space of the apparatuses corresponds to the action range 2 in the embodiment. External disturbances in the installation space of apparatuses include replenishment and disposal of the apparatuses. When the installation space is a shared space with other systems, external disturbances from those other systems may also be added.

An image captured by the camera is transmitted to the computer. The computer uses an object detection model to detect an apparatus placed in the installation space of apparatuses. An YOLOv5 model has been used as the object detection model. This detection method corresponds to an operation of the state specification unit 251.

When a question about an installation position of an apparatus is input to the computer, the computer returns the installation position of the apparatus. In the example shown in FIG. 8, the computer uses a REST API, and the YOLOv5 model returns the installation position of the apparatus.

When an instruction for the actuator is input to the computer, the computer controls the actuator according to the instruction. In the example shown in FIG. 8, the computer uses a ChatGPT API to control the actuator based on the input prompt.

When controlled by a computer, the actuator moves the apparatus placed in the installation space. As a result, it is possible to move the apparatus placed in the installation space.

### Other Embodiments

One embodiment of the present invention has been described in detail above with reference to the drawings. However, the specific configuration is not limited to the description above, and various design modifications are possible within a scope of the present invention.

According to the present invention, it is possible to provide a system having self-maintenance capabilities.

### REFERENCE SIGNS LIST

1 System
11 Management server
111 Reception unit
112 Communication unit
113 Calculation unit
114 State recognition unit
115 Ordering unit
116 Ideal state estimation unit
117 Command unit
21 Robot
22 Traveling device
23 Manipulator
24 Sensor
25 Control unit
251 State specification unit
252 Control quantity calculation unit
253 Instruction unit
26 Communication unit

What is claimed is:

1. A system comprising a management server, a robot, and a sensor that measures an environment including a space of an action range of the robot, wherein the management server includes comprises:
a reception unit configured to receive a mission; and
a command unit configured to generate a command on the basis of the mission and transmit the command to the robot,
wherein the command includes a first command representing a state after execution of the mission, and
the robot includes a state specification unit configured to specify an environmental state of the robot including a state of an article handled by the robot on the basis of measurement data of the sensor, and
an instruction unit configured to receive the command and drive the robot so that a state of the robot approaches a state represented by the command on the basis of a difference between the specified state and the state represented by the command.

2. The system according to claim 1, wherein the instruction unit drives the robot so that a difference between the state of the robot and the state represented by the first command satisfies a predetermined requirement, and
when the first command has not been received, drives the robot so that a difference between the state of the robot and an ideal state of the robot satisfies a predetermined requirement.

3. The system according to claim 2, wherein the robot receives a second command representing the ideal state of the robot from the management server.

4. The system according to claim 1, wherein the robot includes a control quantity calculation unit for determining a drive quantity using a reinforcement learning algorithm that uses a reward based on a difference between a state of the robot and the state represented by the command.

5. The system according to claim 1, wherein the management server includes an ordering unit that orders replenishment of missing articles in the state of the robot for the state represented by the command.

6. The system according to claim 5, wherein the state specification unit collates data of an article received in response to the order measured by the sensor with content of the order placed by the ordering unit, and manages the article.

7. The system according to claim 2, wherein the management server includes an ideal state estimation unit that estimates, as the ideal state, a state in which a future mission is executable on the basis of a mission executed in the past.
